(19) United States
(12) Patent Application Publication
(10) Pub. No.: US 2008/0009411 A1
(43) Pub. Date: Jan. 10, 2008

(54) Method for Manufacturing Absorbent having Function of Suppressing Leakage of Formaldehyde

(76) Inventor: Hsien-Chih Lin, Taichung (TW)

Correspondence Address: HDSL, 4331 STEVENS BATTLE LANE, FAIRFAX, VA, 22033, US

(21) Appl. No.: 11/428,595

(22) Filed: Jul. 5, 2006

(51) Int. Cl. B01J 20/00; C08B 37/08

(52) U.S. Cl. 502/404; 536/20

(57) ABSTRACT

A method for manufacturing absorbent has function of suppression leakage of formaldehyde. The method includes adding chitosan into a solvent, adding acid into the obtained chitosan solution and adding a phenol solution into the chitosan solution having acid in it. The obtained absorbent has the function of absorbing formaldehyde, so as to increase security to workmen.

### BACKGROUND OF THE INVENTION

1. Field of the Invention

The present invention relates to a method for manufacturing absorbent having function of suppression leakage of formaldehyde. More particularly, it relates to a method of forming absorbent having function of absorbing formaldehyde, so as to increase security to workmen.

2. Background of the Invention

It is known to public that, the polywood had been widely used in the furniture and building materials of nowadays. The polywood is formed by binding a plurality of boards together. The resins used for binding the boards are known have contained a large quantity of formaldehyde. Because formaldehyde is volatile substance, it not only has stingy foul smell, but also is corrosive. Thus it would not only be volatilized from the resins, and, when the volatilized formaldehyde enters into human bodies, the human bodies shall be harmed. Consequently, the worker man who works in the environment of resins is easy to cause damage of the respiratory organs.

It is also known to public that, chitin and chitosan are bio-polymers manufactured from natural materials. It can be well-matched with creatures; it is non-poisonous, containing organic activities and can be dissolved by organic bodies. Therefore, it can be widely utilized in healthy foods, pharmaceutical goods, food processing, cosmetics, spinring industries, environmental protection, agriculture, chemical industry etc.

Chitin is found in the exoskeletons of crustaceans, insect cuticles, organs of the mollusks, and fungal cell walls. The difference between chitin and chitosan is the degree of the deacetylation. Chitin is highly acetylated glucosamine. General speaking, chitin itself is not soluble in the water. Therefore, it requires a soluble medium for forming the water-soluble chitosan. In other words, the distinction between chitin and chitosan is based on the solubility in the dilute acid solution (for example, 2% acetic acid). That is in the mixture of chitin and chitosan under acetic acid, the soluble part is chitosan, and the insoluble part is chitin. In general, chitin is extracted from crustacean shell and it contains 15% of amine and 85% of acetyl group. When the deacetylation degree is over 70%, it can transform into the water-soluble chitosan which can be dissolved in the dilute acid solution. In other words, chitin having 70% and/or more of amine is called chitosan.

The water-soluble chitosan is commonly produced by the following process. First, the organic acid is added into the water-swollen chitin for dissolution. Therefore, chitin in a swollen state can be dissolved in the acid solution. However, the above process only adds chitin in the acid solution for forming a gel from the surface of chitin, while it is not completely dissolved into the water. Also, it requires other complicated process to complete, such as alkali thermal hardening method, and enzyme method.

According to the above prior art, even the chitin structure is adjusted, it is not easy for chitin to keep a liquid state during transmission. Furthermore, when chitin is preserved in a liquid state for a period, it is easy to cause deterioration. For example, the color becomes brown, and the liquid becomes turbid. Further, when the concentration of the liquid chitin is higher, it can cause a solid crystal form.

### SUMMARY OF THE INVENTION

Consequently, it is our object of effort to make chitosan show its functions of protecting humans' health.

According to the method for manufacturing absorbent having function of suppressing leakage of formaldehyde of present invention, because the obtained absorbent has the function of suppressing leakage of formaldehyde, thus when the resins are used in the companies of building materials or furniture, then there is no volatilization of formaldehyde, and people will not be harmed due to volatilization of formaldehyde. This is another object of present invention.

Additional features and advantages of the invention will be set forth in the detailed description which follows, and in part will be readily apparent to those skilled in the art from the description or recognized by practicing the invention as described in the written description and claims hereof, as well as the appended drawings.

### BRIEF DESCRIPTION OF THE DRAWINGS

FIG. 1 is flow chart showing the first example of the method for manufacturing absorbent having function of suppressing leakage of formaldehyde of present invention;

FIG. 2 is flow chart showing the second example of the method for manufacturing absorbent having function of suppressing leakage of formaldehyde of present invention; and

FIG. 3 is flow chart showing the third example of the method for manufacturing absorbent having function of suppressing leakage of formaldehyde of present invention.

### DESCRIPTION OF THE PREFERRED EMBODIMENTS

The absorbent obtained by the method of present invention can be formed in liquid phase or solid phase having water or alcohol or its water solution as main components. In addition, the absorbent obtained by the method of present invention contains phenols and chitosan at the same time. After experiment, it is approved shall greatly raise the ability of absorbing formaldehyde.

The method for manufacturing absorbent having function of suppressing leakage of formaldehyde of present invention is to manufacture an absorbent having phenols and chitosan simultaneously. Wherein, the chitosan can be obtained from chitin, the applicant has filed another application for manufacturing chitin, while the method for manufacturing absorbent having function of suppressing leakage of formaldehyde of present invention has the following preferred embodiments:

### EXAMPLE 1

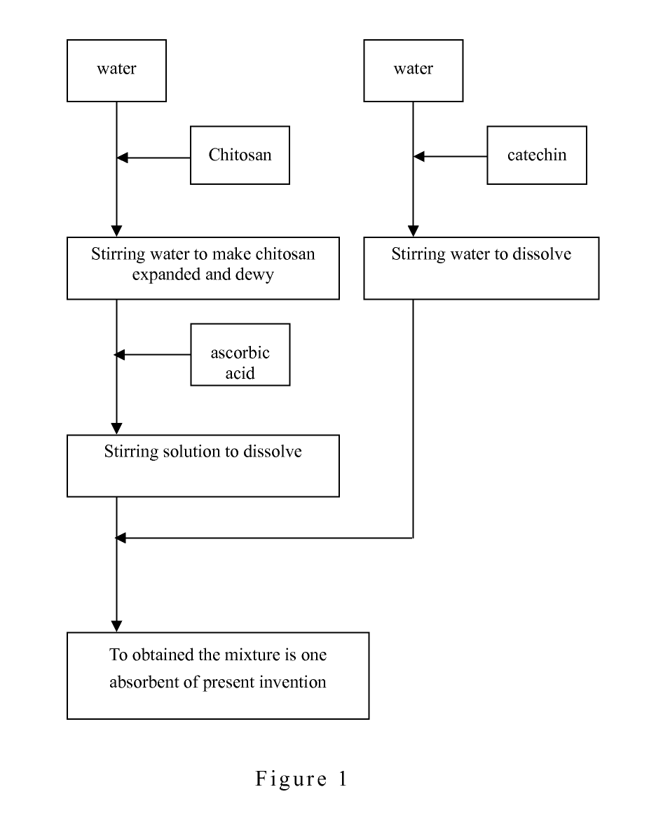

As shown in FIG. 1, the first example for manufacturing absorbent having function of suppressing leakage of formaldehyde of present invention includes the steps of: 1. adding 1.5 gm of chitosan into 47.0 gm of water, and stirring the water to make chitosan expanded and dewy; 2. adding 1.5 gm of ascorbic acid into the solution obtained in step 1 and proceed the second stirring, so as to completely dissolve said chitosan and ascorbic acid into water; 3. on the other hand, adding 1.5 gm of catechin into 48.5 gm of water and stirring the water to completely dissolve the catechin; 4. finally, adding the water solution having the catechin into said water containing chitosan and ascorbic acid. Then the obtained mixture is the absorbent of present invention.

### EXAMPLE 2

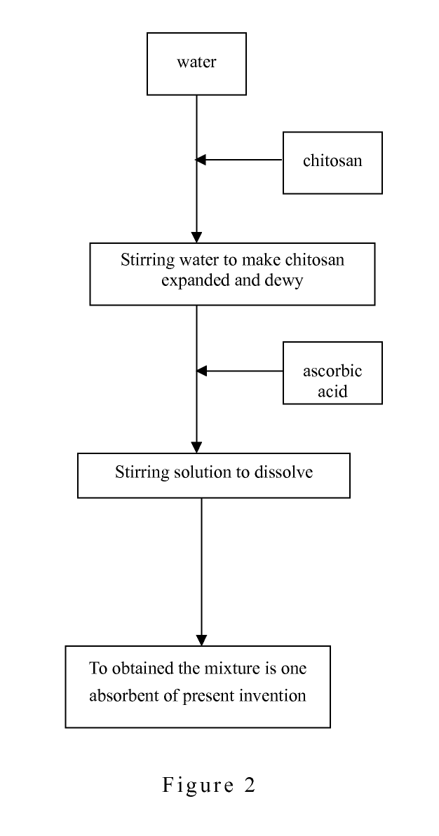

As shown in FIG. 2, the second example for manufacturing absorbent having function of suppressing leakage of is formaldehyde of present invention includes the steps of: 1. adding 3 gm of chitosan into 94 gm of water, and stirring the water to obtain chitosan which is expanded and dewy; 2. adding 3 gm of ascorbic acid into the solution obtained in step 1 and proceed the second stirring, so as to completely dissolve said chitosan and ascorbic acid into water, then the absorbent of example 2 of present invention is obtained.

### EXAMPLE 3

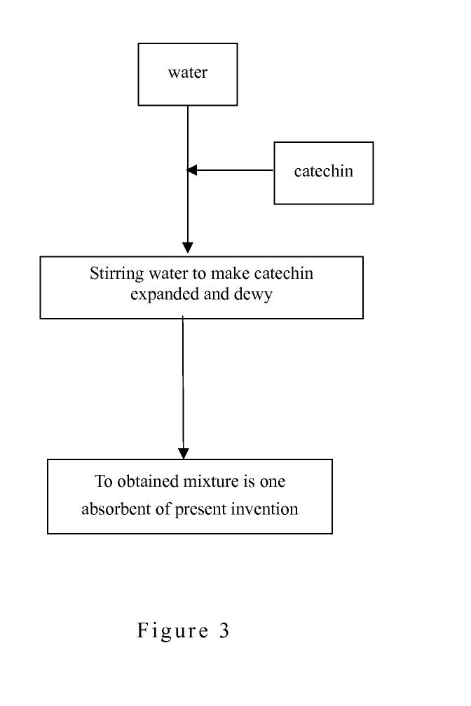

As shown in FIG. 3, the third example for manufacturing absorbent having function of suppressing leakage of formaldehyde of present invention is to obtain an absorbent from water solution of catechin. The step for manufacturing this absorbent is: adding 3 gm of catechin into 97 gm of water and stir it to make catechin be completely dissolved in water.

The viscosity of said chitosan to be used in Examples 1-3 is 10 mPa·s, while the purity of catechin is 60%.

When the main component of absorbent is water, in 100 gm of absorbent, it contains 0.01 gm˜50 gm of phenol and 0.01 gm˜10 gm of chitosan, preferably, pH value is 2 to 7 and showing the absorbent is acid. While the viscosity of absorbent is preferably below 30 mPa·s.

The absorbent having water as the main component can be dehydrated, dried, crumbled to obtain solid absorbent. The phenols and chitosan of solid absorbent exist in solid state. The granular sizes of absorbent is properly above 10 mashes, preferably above 40 meshes, and most preferably, in 40˜100 meshes. The mixing rate of chitosan and phenols is 1:0.1˜1:10, preferably, 1:0.5˜1:5.

### EXAMPLE 4

Said solvent (water) can be replaced by alcohol, preferably, the alcohols having low boiling point. For example: methanol, ethanol, propyl alcohol etc., wherein, ethanol is the best one. When the solvent is a mixture of water and alcohol, the mixing rate of alcohol to water is preferably, 80:20.

### Discussion

Phenols can react with formaldehyde and has chemical absorbing ability. Phenols include monohydric phenol, bihydric phenols, trihydric phenols, derivatives of monohydric phenols, derivatives of bihydric phenols and derivatives of trihydric phenols.

The bihydric phenols include pyrocatechol, resorcinol, hydroquinone etc. The trihydric phenols include pyrogallotannin, phloroglucinol, hydroxyquinol etc. The derivatives of monohydric phenols include methylphenol, and chemicals of C₆H₅(R)OH type. The derivatives of bihydric phenols include laccol, pelargonidin, anthocyan, catechin etc. of C6H₃(R)(OH)₂ type chemicals. The derivatives of trihydric phenols include delphinine and other chemicals of C₆H₂(R)(OH)₃ type. The most suitable phenol is catechin.

The preferable percentage of phenols is: 100 gm of absorbent contains 0.01˜50 gm phenols, the most preferable percentage of phenols is 0.1 gm˜10 gm.

Chitosan can react with formaldehyde to generate schiff, such that the absorbent of present invention has the ability of absorbing formaldehyde. In the absorbent of present invention, the content of chitosan is: 100 gm of absorbent (solution) contains 0.01 gm˜10 gm of chitosan, preferably, 0.5 gm˜5 gm of chitosan. If the viscosity of chitosan is over 30 mPa·s, then the concentration of chitosan then becomes 1.5 wt % over, as a result, the viscosity is increased and will be difficult in application, it is then not a proper condition. The proper viscosity of absorbent is below 30 mPa·s, the preferable viscosity is below 15 mPa·s, the most preferable is 5˜15 mPa·s. The proper deacetylation degree of chitosan is over 60%, the most preferable deacetylation degree of chitosan is over 90%.

If the absorbent contains both phenols and chitosan, the functions then will become twice, such that the ability of absorbent for absorbing formaldehyde would be raisen, the mixing rate of chitosan to phenol is from 1:01 to 1:10, preferably, 1:0.5˜1:5.

Preferably, the absorbent is acid, such that chitosan can be accurately dissolved. The acids can be added into water include: organic acids, inorganic acids etc., wherein, the organic acids includes: ascorbic acid, acetic acid, butyric acid, isobutyric acid, malic acid, formic acid, oxalic acid etc. From the view point of preventing oxidization of phenols, ascorbic acid is the best. The inorganic acids includes: hydrochloric acid, nitric acid and hyperchloric acid etc. The above examples of inorganic acids are strong acids. Consequently, in view of safety, the organic acids are much suitable then inorganic acids. The pH value of absorbent is 2˜7, preferable values are 3˜7, and most preferable values are 4˜6.

### Experiment

TABLE 1

| | Volatilized quantity of |
|---|---|
| Absorbents | formaldehyde (mg/L) |
| Water solution including 1.5 wt % of chitosan, | 0.03 |
| 1.5 wt % of catechin | |
| Water solution including 3 wt % of chitosan | 0.34 |
| Water solution including 3 wt % of catechin | 0.16 |
| Control liquid (water without chitosan | 0.54 |
| and catechin) | |

wt % = (weight of specified substance/weight of water) × 100

The experiment for testing the ability of absorbing formaldehyde is done according to the method disclosed in JIS standard. The absorbent is firstly smeared onto test piece, and the volatilized quantity of formaldehyde is then measured. Eleven pieces of ploywood are used for every kind of absorbent. The polywood is a 3 mm×50 mm×150 mm of Fl polywood. On the surface of ploywood, 10 gm of absorbent is smeared and naturally dried.

From table 1, it can be seen that the absorbent produced by water solution including chitosan and catechin can depress the volatilized quantity of formaldehyde as to 1/11 of the absorbent produced from water solution having chitosan only. On the other hand, the absorbent produced by water solution including chitosan and catechin can depress the volatilized quantity of formaldehyde as to ⅕ of the absorbent produced from water solution having catechin only. Furthermore, the absorbent produced from water solution having chitosan only. On the other hand, the absorbent produced by water solution including chitosan and catechin can depress the volatilized quantity of formaldehyde as to ⅛ of the absorbent produced by water solution.

### Function of Present Invention

The absorbent obtained by the method of present invention can be smeared onto building materials, furniture materials and decorative materials. When the absorbent is in liquid phase, and if the main component is water, by drying the absorbent, the phenols and chitosan then can uniformly spread on the surface of base substance (for example, polywood). And the phenols and chitosan can absorb formaldehyde generated from the base substance, so as to depress the volatilization of formaldehyde. If the absorbent is spread in the atmosphere having formaldehyde, then the formaldehyde in the air can be absorbed.

In conclusion from above, the absorbent obtained by the method of present invention can achieve the functions of depressing the leakage of formaldehyde and then reduced the haggard of formaldehyde due absorb it.

The method of present invention and the subject absorbent do not have seen in any printed matters or in the market. It undoubtedly includes novelty in it. Furthermore, the unique characteristics and functions of present invention can not be matched by connectional objects, it then comprises progressiveness in comparison with conventional skill.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the method may be varied substantially without departing from the spirit of the invention and the exclusive use of all modifications, which come within the scope of the appended claims, is reserved.

What is claimed is:

1. A method for manufacturing absorbent having function of suppressing leakage of formaldehyde, comprising the following steps:
(a) adding chitosan into a solvent, and then stirring the solvent to make chitosan expanded and dewy;
(b) adding acid into the solution obtained in step (a) and proceed the second stirring, so as to completely dissolve said chitosan and acid into said solution;
(c) adding a phenol into another solvent and stirring, so as to make said phenol completely dissolved into said solvent to become phenol solution; and
(d) adding phenol solution obtained in step (c) into the solution obtained in step (b), and stirring to mix together.

2. A method for manufacturing absorbent having function of suppressing leakage of formaldehyde as claimed in claim 1, wherein the quantity of said chitosan is 0.1˜10 wt % of the absorbent.

3. A method for manufacturing absorbent having function of suppressing leakage of formaldehyde as claimed in claim 1, wherein the quantity of said phenol is 0.01˜50 wt % of the absorbent.

4. A method for manufacturing absorbent having function of suppressing leakage of formaldehyde as claimed in claim 1, wherein the pH value of said absorbent is 2˜7, preferably 3˜7, and most preferably 4˜6.

5. A method for manufacturing absorbent having function of suppressing leakage of formaldehyde as claimed in claim 1, wherein the viscosity of said absorbent is below 30 mPa·s, preferably below 15 mPa·s, and most preferably 5˜15 mPa·s.

6. A method for manufacturing absorbent having function of suppressing leakage of formaldehyde as claimed in claim 1, wherein said phenol is selected from monohydric phenol, bihydric phenols, trihydric phenols, derivatives of monohydric phenols, derivatives of bihydric phenols and derivatives of trihydric phenols.

7. A method for manufacturing absorbent having function of suppressing leakage of formaldehyde as claimed in claim 6, wherein bihydric phenols include pyrocatechol, resorcinol, hydroquinone etc., the trihydric phenols include pyrogallotannin, phloroglucinol, hydroxyquinol etc., the derivatives of monohydric phenols include methylphenol, and chemicals of C₆H₅(R)OH type.

8. A method for manufacturing absorbent having function of suppressing leakage of formaldehyde as claimed in claim 6, wherein derivatives of bihydric phenols include laccol, pelargonidin, anthocyan, catechin etc, of C6H₃(R)(OH)₂ type chemicals.

9. A method for manufacturing absorbent having function of suppressing leakage of formaldehyde as claimed in claim 6, wherein derivatives of trihydric phenols include delphinine and other chemicals of C₆H₂(R)(OH)₃ type. The most suitable phenol is catechin.

10. A method for manufacturing absorbent having function of suppressing leakage of formaldehyde as claimed in claim 6, wherein the proper deacetylation degree of chitosan is over 60%, the most preferable deacetylation degree of chitosan is over 90%

11. A method for manufacturing absorbent having function of suppressing leakage of formaldehyde as claimed in claim 1, wherein the mixing ratio of chitosan an and phenol (chitosan: phenol) is 1:0.1 to 1:10, preferably is 1:0.5 to 1:5.

12. A method for manufacturing absorbent having function of suppressing leakage of formaldehyde as claimed in claim 1, wherein the acid of organic acid is an acid selected from ascorbic acid, acetic acid, butyric acid, isobutyric acid, malic acid, formic acid, oxalic acid etc., and the most preferable organic acid is ascorbic acid.

13. A method for manufacturing absorbent having function of suppressing leakage of formaldehyde as claimed in claim 1, wherein the acid of inorganic acid is selected from hydrochloric acid, nitric acid and hyperchloric acid.

14. A method for manufacturing absorbent having function of suppressing leakage of formaldehyde as claimed in claim 1, wherein said solvent is water.

15. A method for manufacturing absorbent having function of suppressing leakage of formaldehyde as claimed in claim 1, wherein said solvent is alcohol.

16. A method for manufacturing absorbent having function of suppressing leakage of formaldehyde as claimed in claim 1, wherein said solvent is the mixture of water and alcohol.

17. A method for manufacturing absorbent having function of suppressing leakage of formaldehyde as claimed in claim 16, wherein the preferable ratio of alcohol to water is 80 to 20.
